(19) United States
(12) Patent Application Publication
(10) Pub. No.: US 2018/0078888 A1
(43) Pub. Date: Mar. 22, 2018

(54) CERAMIC FILTER AND METHOD FOR FORMING THE FILTER

(71) Applicant: ASK Chemicals LLC, Dublin, OH (US)

(72) Inventors: Robert Alan GAGE, Rushville, NY (US); David Andrew NORRIS, Almond, NY (US); Shannon Frederick FORSYTHE, Hornell, NY (US); Joerg KROKER, Powell, OH (US)

(21) Appl. No.: 15/823,729

(22) Filed: Nov. 28, 2017

Related U.S. Application Data
(63) Continuation-in-part of application No. PCT/US16/43391, filed on Jul. 21, 2016.
(60) Provisional application No. 62/195,372, filed on Jul. 22, 2015.
(60) Provisional application No. 62/478,852, filed on Mar. 30, 2017.

(51) Int. Cl. B01D 39/20; B01D 29/00; B29C 64/124; C22B 9/02; B28B 7/34; B28B 1/30; C04B 38/06; C04B 38/00

(52) U.S. Cl. CPC B01D 39/2075; B01D 29/0093; B29C 64/124; C22B 9/023; B33Y 10/00; B28B 1/30; C04B 38/0615; C04B 38/0009; B28B 7/342

(57) ABSTRACT

A filter element, useful for filtering molten metals and the like, is made from a precursor or template (10) having at least two layers (20). Each layer is assembled from three-dimensional geometric cages (22), joined in fixed relationship to each other: Some embodiments include a peripheral member (26) that encompasses the layer. In such cases, spacer members (28) can span the peripheral members to hold the layers in fixed spaced-apart relationship. In other embodiments, at least some of the cages in adjacent layers can be joined in fixed relationship, providing the spaced-apart relationship. The cages can be built from linear segments of a material joined in a pattern based on the edges of the geometric solid. The template may be formed by an automated technique, such as three-dimensional printing. If manufactured from a polymer, the precursor is coated with a ceramic slurry and calcined to provide the filter element.

### CROSS-REFERENCE TO RELATED APPLICATIONS

This application is a by-pass continuation-in-part of PCT/US2016/043391, filed on 21 Jul. 2016, which is a non-provisional of U.S. provisional patent application 62/195,372, filed on 22 Jul. 2015. This application makes a priority claim to each of these applications and each is incorporated by reference as if fully recited herein. This application also makes a claim of priority to U.S. provisional application 62/478,852, which was filed on 30 Mar. 2017, the content of which is also incorporated by reference as if fully recited herein.

### TECHNICAL FIELD

The disclosed embodiments relate to a method for preparing a filter medium, especially from a ceramic material, and especially using three-dimensional printing technology. Such a filter is useful for filtering dross, inclusions and the like from molten metal in a casting process. This application is also directed to the filter formed by the method.

### BACKGROUND

When pouring a molten metal, some impurities in the metal will remain in a solid state. Some of these impurities will be oxides of the metal that are formed by exposure of the molten metal to atmospheric oxygen. It is common to use a ceramic filter to remove these, due to the temperature of the metal being handled and because of the affinity exhibited by oxide-based impurities to adhere to ceramic material. The reactive nature of aluminum and aluminum alloys make them particularly likely to form the undesired oxides, requiring filtration.

Ceramic filters are also useful in filtering water. However, the techniques useful for forming ceramic powders into water filters, such as sintering ceramic powders, are not useful in manufacturing filters for molten metals, as the water filters are intended to remove materials at the micron level, rather than at the much larger flow area required to pass the molten metal quickly, to preserve it in a molten state.

An example of recent work in this field is insightful, although it appears that significant problems still exist for solution. In U.S. Pat. No. 8,794,298 to Schlienger, the need to provide a ceramic filter with the complex paths desired for good filtration is described. The inventors there indicate that in the prior art it was known to infiltrate spheres of foamed polystyrene with a ceramic slurry. When the slurry was fired, the polystyrene would burn out, leaving a network of randomly-directed ligaments that supported a tortuous flow path of pores previously occupied by the spheres. The deficiency of this technique is that the close proximity of some of the spheres presented fragile ligaments that could break off in use, actually causing the filter to be a source of inclusions.

Another technique described as inadequate by the '298 patent was a packed bed of ceramic or polymeric particles in which the interstices would provide the path, albeit a path essentially lacking in pores. This solution leaves an undesirably high percentage of the filter volume occupied by the particles. The solution taught in the '298 patent is to provide a three-dimensional “engineered and electronically-defined geometry” in which pore size, tortuosity and the minimum diameter of the ligaments is predetermined, although none of these details are provided. Using the three-dimensional predetermined geometry as a template, the '298 patent describes using a stereolithography technique to form the reticulated network by selective laser activation of a resin that contains the ceramic material and is photopolymerizable. The polymer-ceramic composite network is then reduced to ceramic by known techniques, including burnout.

A somewhat earlier technique for preparing a ceramic filter element having a three-dimensional reticulated skeleton structure having interconnected pores is to impregnate with ceramic slurry a reticulated synthetic resin foam having no cell membranes, as taught in U.S. Pat. No. 6,203,593 to Tanuma. In each case in the '593 patent, the reticulated resin foam is formed into a cylindrical shape prior to the impregnation with ceramic, so that all of the ceramic filter elements provided have an unimpeded axial flow path and any filtering activity occurs by flow in the radial direction of the cylindrical element. This would suggest that there is a great amount of difficulty in achieving penetration of the ceramic slurry into the reticulated polymer foam.

It is therefore an unmet advantage of the prior art to provide a ceramic filter element for removing impurities in a molten metal pour, where the filter element has a proper balance of tortuosity and structural stability.

### SUMMARY

This and other unmet advantages are provided by the device and method described and shown in more detail below.

Some of the unmet advantages are met by a precursor for a device for filtering molten metal. The device has at least two layers of filter element, each layer of filter element comprising a plurality of three-dimensional geometric cages joined in fixed relationship to each other.

In some embodiments, each layer of the filter precursor further comprises a peripheral member that encompasses the layer. In some of these embodiments, there are a plurality of spacer members that span the peripheral members of a pair of adjacent layers, holding the layers in fixed spaced-apart relationship.

In other embodiments, the layers are held in spaced-apart fixed relationship by joining a plurality of the three-dimensional geometric cages in one layer with a three-dimensional geometric cage in an adjacent layer.

In many of the filter precursors, each of the three-dimensional geometric cages will comprise a plurality of linear segments of a material joined to each other in the shape of a geometric solid, such that each linear segment represents an edge of the geometric solid.

In particular, each of the three-dimensional geometric cages may comprise twenty linear segments of a material arranged in the shape of a partially-truncated octahedron. Such a shape has a top and a bottom square face and eight trapezoidal faces, the longest edges of the trapezoidal faces defining an equator between the top and bottom square faces. The equator has four edges and four vertices.

When the partially-truncated octahedron shape is used, there may also be a plurality of linear support members, arranged in parallel relationship across the layer and subdividing the layer into a plurality of rows. Between each pair of adjacent linear support members, that is, in each row, a plurality of the cages having the shape of a partially-truncated octahedron are joined at the equator to each of the linear support members defining the row.

In this arrangement, the cages having the shape of a partially-truncated octahedron can be arranged along each row in spaced-apart relationship from each of the adjacent cages. However, in other embodiments, the cages can be arranged along each row, joined to each of the cages adjacent thereto.

In another embodiment, each of the three-dimensional geometric cages can comprise thirty-six linear segments of a material arranged in the shape of a fully-truncated octahedron having six square faces and eight trapezoidal faces. In such case, each of the fully-truncated octahedron cages can be joined to adjacent fully-truncated octahedron cages in an edge-to-edge manner, or alternatively, each of the fully-truncated octahedron cages can be joined to adjacent fully-truncated octahedron cages in a face-to-face manner, based upon square faces of the respective cages.

The filter precursor of the inventive concept is preferably formed from a thermoplastic material suitable for extrusion through a print head of a 3-dimensional printer or a ceramic in a slurry form suitable for extrusion through a print head of a 3-dimensional printer. In the case of a thermoplastic, a preferred material is an acrylonitrile-butadiene-styrene (ABS) polymer.

In these cases, the precursor is converted into a filter by coating the precursor with a ceramic slurry and calcined.

One method for doing this is to generate, on a computing device, a three-dimensional model of a filter precursor according to claim 1. This model may be implemented as an instruction set on a three-dimensional printer. The instruction set is then useful for constructing, using the three-dimensional printer, the filter precursory depositing a material in a layer by layer process according to the instruction set and, especially if the material used is a polymer, coating the constructed filter precursor with a ceramic slurry and calcining the coated filter precursor.

When the material used is a ceramic, simply calcining the precursor to provide a filter of refractory material may be sufficient, but coating may be useful to increase tortuosity of the filter.

### BRIEF DESCRIPTION OF THE DRAWINGS

A better understanding of the disclosed embodiments will be obtained from a reading of the following detailed description and the accompanying drawings wherein identical reference characters refer to identical parts and in which:

FIG. 1 is a top perspective view of a filter element template;

FIG. 2 is a top perspective view of the template of FIG. 1, after being coated with a ceramic slurry and calcined;

FIG. 3A is a front perspective view of a geometrical octahedron, having truncated polar vertices;

FIG. 3B is a front perspective view of a geometrical octahedron, having all vertices truncated;

FIG. 4 is a top plan view of a portion of a layer of the template of FIG. 1;

FIG. 5 is a top plan view of a portion of a first alternative layer of the FIG. 1 template;

FIG. 6 is a perspective view of a portion of a second alternative layer of the FIG. 1 template; and

FIG. 7 is a top plan view of a portion of FIG. 5, illustrating a further embodiment.

### DETAILED DESCRIPTION

The development of three-dimensional printing techniques allows the precise build-up of models in a layer plastic deposition (LPD) technology. One manufacturer of a three-dimensional printer is Zortrax, of Poland. In a typical Zortrax printing device, a filament of polymeric resin, such as an acrylonitrile-butadiene-styrene (ABS) copolymer, is fed through an extruder at the end of a robotically-controlled arm onto a heated platform in a precise manner, building up a structure according to a predetermined model in a layer by layer manner.

The three-dimensional printing may be achieved using other known technologies, provided that there is a computer model of the object to be “printed.” It is understood that since 2010, the American Society for Testing and Materials (ASTM) has developed a set of standards that classify so-called “additive manufacturing technologies” into seven categories. They are: 1) vat photopolymerization; 2) material jetting; 3) binder jetting; 4) material extrusion; 5) powder bed fusion; 6) sheet lamination; and 7) directed energy deposition.

In vat photopolymerization, a container of liquid photopolymer resin is selectively hardened or cured by a light source, typically a laser. The most common technology of this type uses an ultraviolet light source in a process referred to as stereolithography, or SLA. Other techniques in this category are continuous liquid interface production, or CLIP, film transfer imaging and solid ground curing.

Material jetting applies droplets of material through a small diameter nozzle in a manner that is analogous to ink-jet printing, but applied in a layer-by-layer manner and hardened by UV light. A provider of this technology is Stratasys.

Binder jetting uses two materials. A powder base material is spread in equal layers in a build chamber. Liquid binder, applied through jet nozzles, “glues” the base material into the shape of the desired object. Once completed, the excess base powder is cleaned off of the printed item, which is cured, usually by light. A typical base powder may be a metal powder. A provider of this technology is ExOne.

The most commonly used method of material extrusion is fused deposition modelling, or FDM. A plastic filament or metal wire is run through an extrusion nozzle which can turn the flow on and off. The nozzle is moved in three-dimensions by the computer model above a table on which the object is built. The primary plastics used are acrylonitrile-butadiene-styrene (ABS) or polylactic acid (PLA). The term FDM is a registered trademark of Stratasys, so the term “fused filament fabrication” or FFF is often used instead.

Powder bed fusion is exemplified by its most common technique, which is selective laser sintering, or SLS. Here, a high power laser fuses small particles of a selected material, layer by layer, into a three-dimensional shape. Clearly, the laser is directed by the computer model of the object to be printed. Exemplary particles may be plastic, metal, ceramic or glass.

In sheet lamination, material in sheets is bound together with external force. The sheets can be metal, paper or a polymer. Metal sheets can be bound by ultrasonic welding and then CNC milled. Paper sheets would typically be glued with an adhesive. A leading company in this technology is Mcor Technologies.

The last of the categories is directed energy deposition. Here, a multi-axis robotic arm directs a nozzle that deposits metal powder or wire on a surface, where an energy source melts it. An exemplary energy source could include laser, electron beam or plasma arc. A company in this technology is Sciaky.

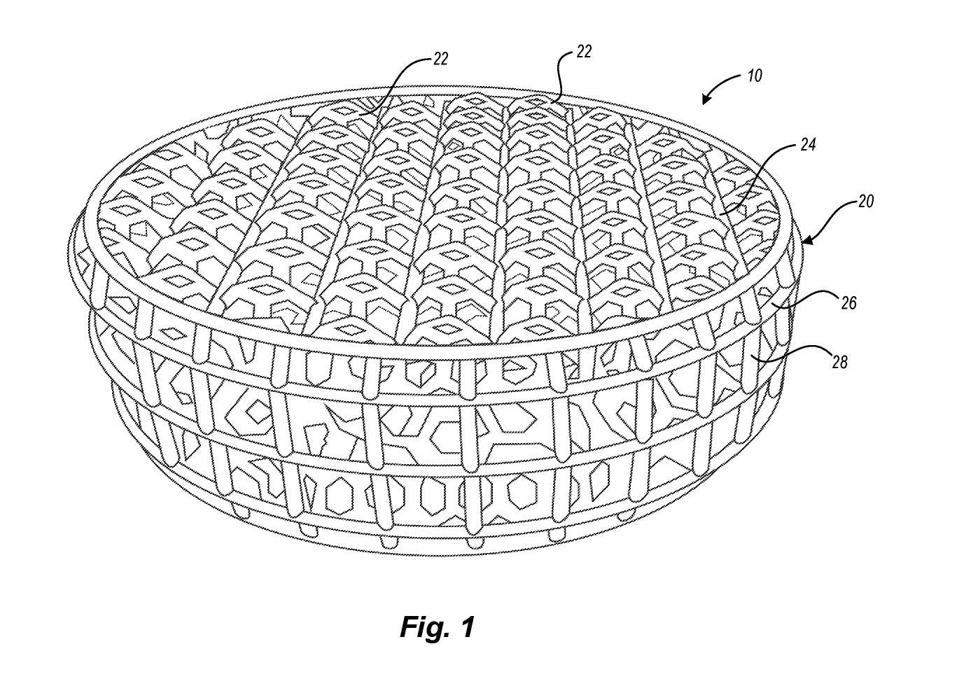

FIG. 1 depicts a top perspective view of an assembled template 10 for making an embodiment of a ceramic filter that incorporates the inventive concept. A typical embodiment of the assembled template comprises two of more layers 20 of three-dimensional geometric cages 22 that are arranged in a fixed predetermined relationship to each other. As will be explained in more detail below, each layer 20 will have the individual cages 22 held in place by being joined to adjacent individual cages 22, a support member 24, a peripheral member 26 or some combination of these. Generally, each three-dimensional geometric cage 22 comprises a plurality of linear segments of a polymer, or, in some cases, a ceramic material. The ceramic material, when used, would be one that is capable of being extruded from a print head, especially a print head of a three-dimensional printer. In a three-dimensional printing method, the template 10 can be built up such that adjacent layers 20 are directly joined to each other, but this is not viewed as a critical aspect of the inventive concept, so individual layers can be built up and then joined to adjacent layers by a separate process or method. In the embodiment depicted, the template 10 has layers 20 that are bounded by a circular peripheral member 26. The individual peripheral members 26 are joined in spaced relationship by spacer members 28. In the depicted embodiment, all structural elements, that is, the cages 22, the support members 24, the peripheral members 26 and the spacer members 28 comprise the same material, whether that is polymer or ceramic.

While FIG. 1 discloses one specific embodiment of the layer 20 used in the template 10, there are clearly alternative embodiments of the layer 20 known to be useful for the inventive concept. For that reason, a more detailed description of some of these embodiments are described in more detail below.

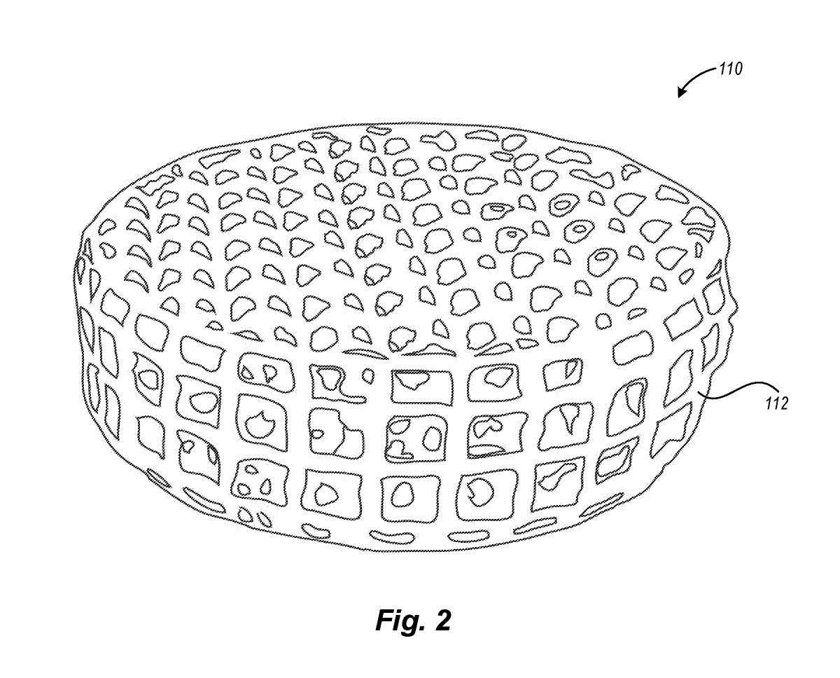

Attention is now directed to FIG. 2, which depicts, in the same front perspective view as FIG. 1, a completed filter 110 that has been produced from the FIG. 1 template. This completion of the filter 110 is necessary when the template is constructed of polymer and is desirable, but not necessary, when the template is constructed of a ceramic material. To transform the template into the completed filter 110, the template is coated with a ceramic slurry and then calcined, resulting in an overall random, but generally continuous, surface 112 of a ceramic material suitable for exposure to molten metal as a filter. The advantage provided by such a coating with ceramic slurry is that the ceramic applied from the slurry increases the closed volume in the filter and also introduces a significant amount of randomness to the otherwise regular structure, providing a higher degree of tortuosity to the product. In some instances, the ceramic slurry will effectively close the hexagonal and square “windows” that are present in the three-dimensional geometric cages.

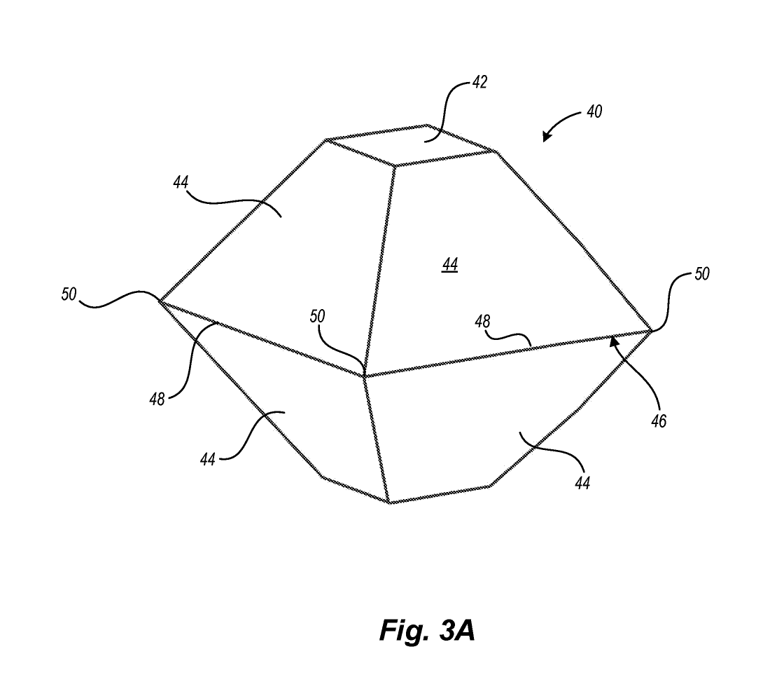

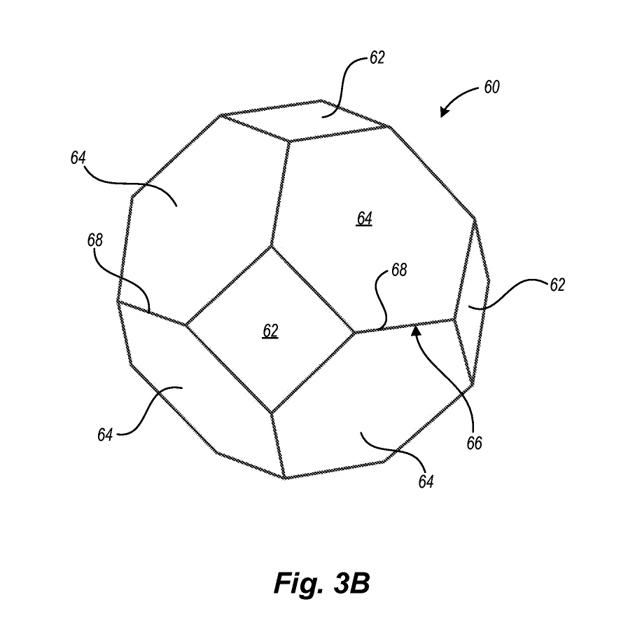

To this point, reference has been made to the use of “three-dimensional geometric cages” as a structural element in the filters embodying the inventive concept. In general, the three-dimensional geometric cages that work will tend to be frames or cages having the shape of a regular polyhedron. A particularly useful such regular polyhedron is an octahedron or a structure derived from an octahedron. As is well known, an octahedron is one of the Platonic solids that has 12 edges, 6 vertices that are disposed in three opposing pairs, the pairs in orthogonal relationship to the other pairs. There are 8 faces, each of which is an equilateral triangle. If one opposing pair of the vertices are truncated, a solid, such as is shown in perspective view in FIG. 3A, obtains. This structure 40, which will be referred to as a “partially-truncated octahedron,” has a top and a bottom square face 42 (only one of which is visible in FIG. 3A) and eight trapezoidal faces 44 (four of which are visible in FIG. 3A). It has an “equator” 46, defined by the four edges 48 that do not intersect either square face 42. The four vertices 50 that remain after the truncation are located on the equator 46.

If the four remaining vertices 50 of the partially truncated octahedron 40 are truncated, the structure 60, shown in perspective view in FIG. 3B, obtains. This structure 60 will be referred to as a “fully truncated octahedron.” It has fourteen faces, six being square faces 62 (three of which are visible in FIG. 3B) and eight being hexagonal faces 64 (four of which are visible in FIG. 3B). There are a total of 36 edges 68 of the same length, with the edges meeting in a total of 24 vertices. The six square faces 62 are arranged in three pairs of opposing square faces. Based upon any of these pairs, an “equator” 66 is defined by four edges 68 that are parallel to a plane defined by the pair of square faces. The fully-truncated octahedron is a “space-filling” solid that can tessellate a three-dimensional space.

It will be understood that other geometric cages, built up from linear segments that define the edges of a geometric solid, may be useful, typically up to and including the icosahedron with its 20 equilateral triangle faces. While it is possible to construct and use more complex structures with more edges and vertices, the incremental benefit from increased filtration capability is greatly diminished.

Also, while it is believed to be preferred to use identical three-dimensional geometrical cages in a given layer, it is possible and may be advantageous in some circumstances to use three-dimensional geometric cages of differing sizes or shapes within a given layer, or to alter sizes or shapes between adjacent layers.

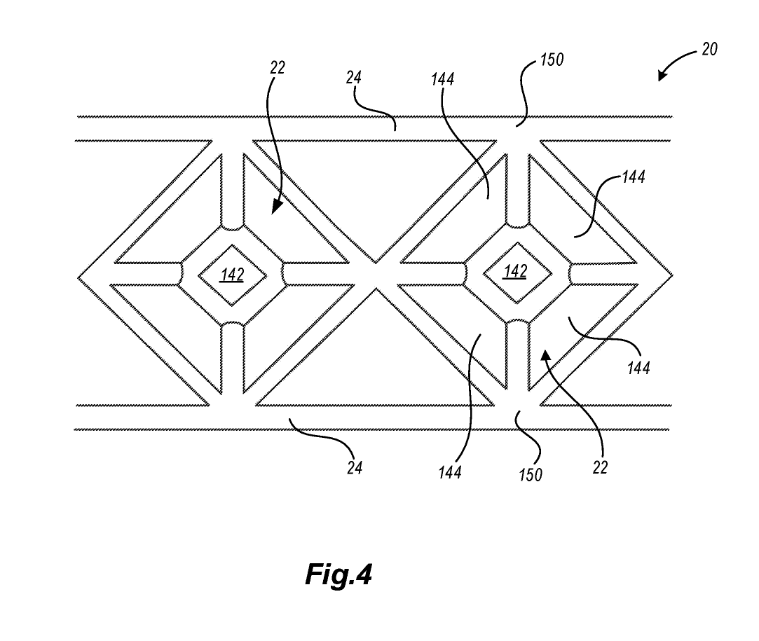

With those definitions in place, attention is now directed to FIG. 4, where a top plan view of a section of the layer 20 depicted in FIG. 1 is illustrated in an enlarged view that allows the details to be better understood. In this case, each cage 22 is formed, as an open frame of linear segments that are in the positions of the edges of the partially truncated octahedron of FIG. 3A. A square face 142 is clearly seen, as are four of the trapezoidal faces 144. Two vertices 150 of each cage 22 are joined to support members 24 and the remaining two vertices are joined to a vertex of an adjacent cage. In variations of this design, the cages 22 could be spaced further apart along the support members 24 so that adjacent cages 22 are not in contact with each other. This allows flexibility in terms of porosity and/or tortuosity. Beyond spacing, the support members 24 allow adjacent rows of cages 22 to be arranged in either a square or a triangular pitch.

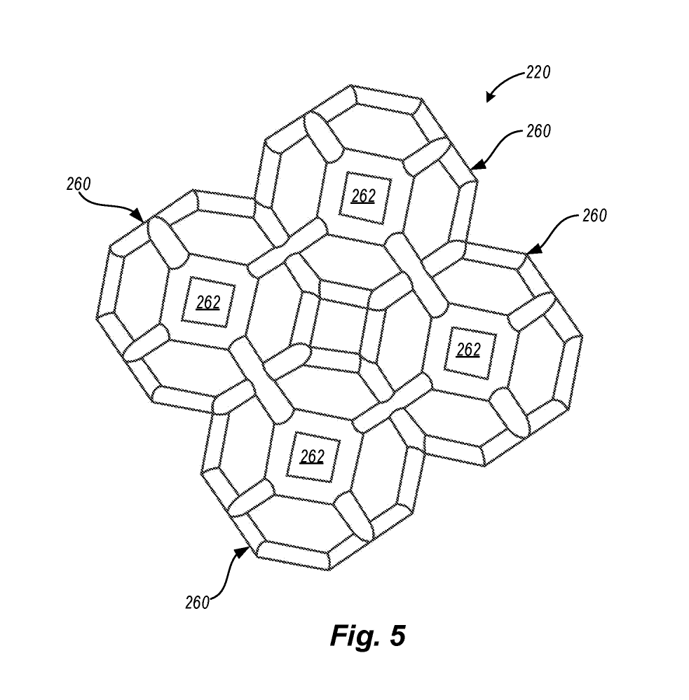

FIG. 5 shows, in top plan view, a different arrangement to provide a layer 220 for a device 10 as in FIG. 1. In this situation, the layer 220 comprises cages 260 that are linear elements shaped in the manner of a fully truncated octahedron, with adjacent cages 260 joined along adjacent edges that define the equator of the cage with reference to the top square face 262. Again, the depiction is only a section of the layer, but illustrates how the layer can be fully built into an essentially planar sheet that can be contained with a peripheral member. This layer 220 can be directly attached to an adjacent layer 220 above or below it by joining the square faces 262, or the layers can be spaced, as in FIG. 1, by spacer members.

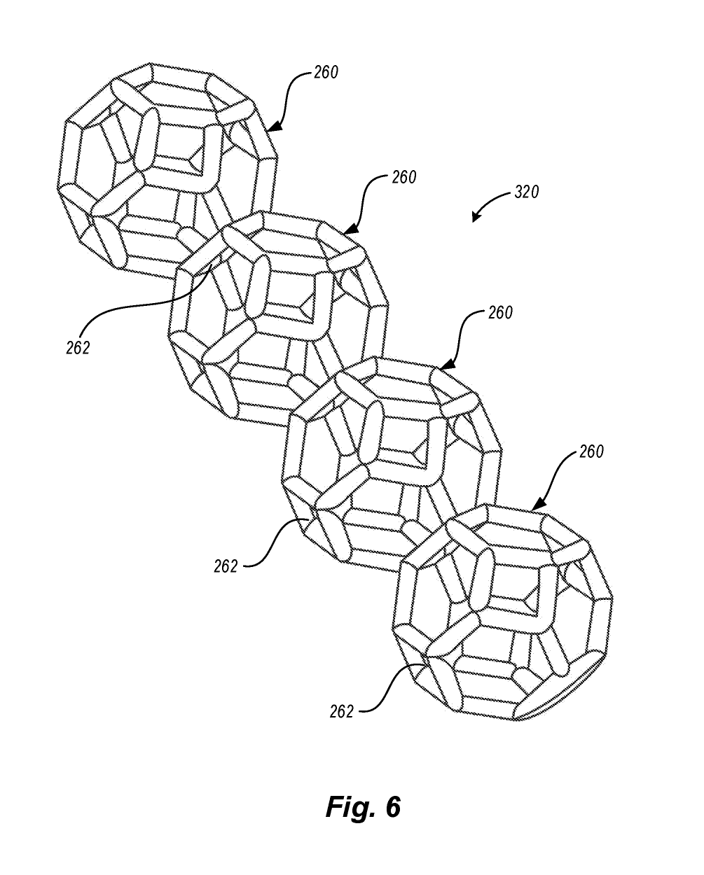

Directing attention to FIG. 6, a further manner of arranging cages 260 is shown in perspective view. Rather than “edge to edge” joining, these cages 260 are matched “face to face,” using a pair of facing square faces 262. This provides another embodiment 320 of a layer, which is, for ease of understanding, presented only in a small section.

In some situations, it may be advantageous to change the diameter of the linear segments of polymer or ceramic that are used to construct the cages, to vary porosity of the filter being assembled.

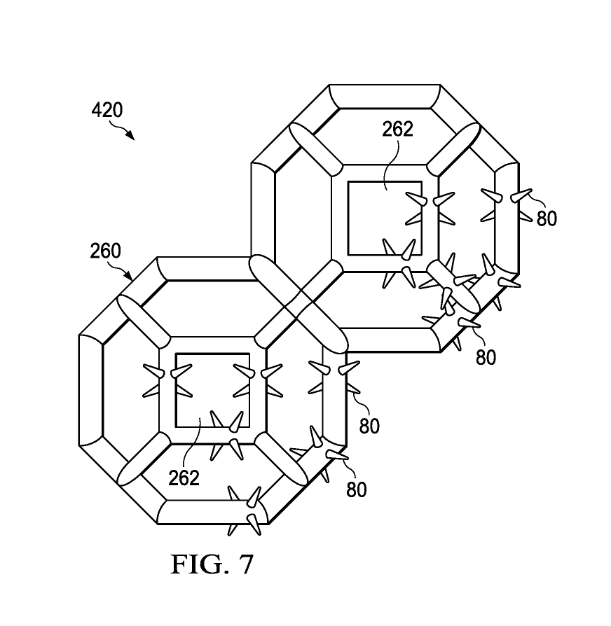

In some other situations, it may be advantageous to use a method for providing varying porosity to the filter being assembled, especially to provide a cage having randomness in the porosity, as illustrated in FIG. 7. In that figure, a portion of the structure of FIG. 5 is presented in top plan view, although it will be recognized that the method will be equally applicable to any of the illustrated embodiments, as well as embodiments that are within the scope of the invention. It has been recognized that three-dimensional printing is often achieved using material extrusion of a polymer or a ceramic through a print head having a fixed diameter, which results in a layer 220 as seen in FIG. 5. In addition to being of uniform diameter, the surface of the individual linear segments will tend to be smooth. The uniformity and smoothness may co-act to provide insufficient purchase of a ceramic slurry when the template is coated.

To achieve this end, and as illustrated in the bottom right portion of FIG. 7, a series of surface irregularities, exemplified in FIG. 7 as elongate spikes 80, are built up on individual linear segments of the cages 260 that make up the embodiment 420 of the layer. These spikes 80 are placed randomly on the linear segments and have random length. As illustrated, the spikes 80 have a uniform diameter, the spike diameter being smaller than the diameter of the linear segments, but the diameter of the spikes may vary, especially if the method used to apply them is a jetting technique instead of an extrusion method. The spikes 80 are also randomly oriented in three-dimensional space. It would be expected that the spikes 80 would be applied by a separate print head and the material of the spikes may be different than the material used for the linear segments. While it is possible that two print heads could operate in unison to manufacture the layer 420, it is expected that a preferred technique may be to first manufacture a layer 220 as in FIG. 5, and then to place the spikes 80 onto the layer, converting it into a layer 420.

Focusing on the embodiment where the surface irregularities are spikes 80, some ranges of size can be proposed. Assuming that the spikes 80 are printed with an extrusion-type head, a typical range of the diameter would be expected to be from about 10% to no more than about 50% of the diameter of the linear segments from which the spikes are placed. The spikes 80 would be expected to have an individual length-to-diameter (L/D) ratio that would be at least about 3:1, and would be no more than about 7:1. For a given filter precursor, the spikes 80 would be expected to cover a significant portion of the L/D range, as a function of the randomization algorithm used in placing them. It is also expected that, when the spikes 80 are used, at least 10% of all of the linear segments will have at least one spike, and that no more than 10% of the linear segments will not have at least one spike. Similar to the embodiment illustrated in FIG. 7, it would be expected to closely position up to three or four spikes 80 (or other types of surface irregularities) in close proximity, although with different spatial orientation.

Once a basic structure for a filter is determined, a computer model can be written that allows construction of the template using a three-dimensional printing technique and device.

Having shown and described a preferred embodiment of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

What is claimed is:

1. A precursor for a device for filtering, comprising:
at least two layers of filter element, each layer of filter element comprising a plurality of three-dimensional geometric cages joined in fixed relationship to each other, wherein each of the three-dimensional geometric cages comprises a plurality of linear segments of a material joined to each other in the shape of a geometric solid, such that each linear segment represents an edge of the geometric solid; and
wherein a significant percentage of the linear segments have at least one surface irregularity extending from the linear segment to facilitate purchase of a coating material.

2. The filter precursor of claim 1, wherein the surface irregularities are in the nature of elongate spikes.

3. The filter precursor of claim 2, wherein each of the elongate spikes has a diameter that is in the range of from about 10% to about 50% of the diameter of the linear segment from which the spikes extends.

4. The filter precursor of claim 2, wherein each of the elongate spikes has a length to diameter ratio that is in the range of from about 3:1 to about 7:1.

5. The filter precursor of claim 2, wherein at least 10% and less than about 90% of all of the linear segments has at least each elongate spike extending therefrom.

6. The filter precursor of claim 2, wherein some of the linear segments have a plurality of elongate spikes extending in close proximity, each of the plurality of elongate spikes having a different spatial orientation.

7. The filter precursor of claim 1, wherein:
each layer further comprises a peripheral member that encompasses the layer.

8. The filter precursor of claim 7, further comprising a plurality of spacer members that span the peripheral members of a pair of adjacent layers, holding the layers in fixed spaced-apart relationship.

9. The filter precursor of claim 1, wherein a plurality of the three-dimensional geometric cages of a pair of adjacent layers are joined in fixed relationship to each other, holding the layers in fixed spaced-apart relationship.

10. The filter precursor of claim 1, wherein each of the three-dimensional geometric cages comprises a plurality of linear segments of a material joined to each other in the shape of a geometric solid, such that each linear segment represents an edge of the geometric solid.

11. The filter precursor of claim 10, wherein each of the three-dimensional geometric cages comprises twenty linear segments of a material arranged in the shape of a partially-truncated octahedron having a top and a bottom square face and eight trapezoidal faces, the longest edges of the trapezoidal faces defining an equator between the top and bottom square faces, the equator having four edges and four vertices.

12. The filter precursor of claim 11, further comprising
a plurality of linear support members, arranged in parallel relationship across the layer and subdividing the layer into a plurality of rows; such that, between each pair of adjacent linear support members, a plurality of the cages having the shape of a partially-truncated octahedron in each row are joined at the equator to each of the linear support members defining the row.

13. The filter precursor of claim 5, wherein each of the three-dimensional geometric cages comprises thirty-six linear segments of a material arranged in the shape of a fully-truncated octahedron having six square faces and eight trapezoidal faces.

14. The filter precursor of claim 13, wherein each of the fully-truncated octahedron cages are joined to adjacent fully-truncated octahedron cages in an edge-to-edge manner.

15. The filter precursor of claim 13, wherein each of the fully-truncated octahedron cages are joined to adjacent fully-truncated octahedron cages in a face-to-face manner, based upon square faces of the respective cages.

16. The filter precursor of claim 1, wherein the material is a thermoplastic polymer suitable for extrusion through a print head of a 3-dimensional printer.

17. The filter precursor of claim 1, wherein the material is a ceramic in a slurry form suitable for extrusion through a print head of a 3-dimensional printer.

18. The filter precursor of claim 16, wherein the polymer is an acrylonitrile-butadiene-styrene (ABS) polymer.

19. A filter for filtering a molten metal, comprising:
a filter precursor according to claim 1 that has been coated with a ceramic slurry and calcined.

20. A method for manufacturing a filter for filtering a molten metal, comprising the steps of:
generating, on a computing device, a three-dimensional model of a filter precursor according to claim 1 and implementing the three-dimensional model as an instruction set on a three-dimensional printer;
constructing, using the three-dimensional printer, the filter precursor by depositing a material in a layer by layer process according to the instruction set;
coating the constructed filter precursor with a ceramic slurry; and
calcining the coated filter precursor.
